(19) United States
(12) Patent Application Publication
(10) Pub. No.: US 2007/0203700 A1
(43) Pub. Date: Aug. 30, 2007

(54) Speech Recognition Apparatus And Speech Recognition Method

(76) Inventor: Soichi Toyama, Saitama (JP)

Correspondence Address: SUGHRUE MION, PLLC, 2100 PENNSYLVANIA AVENUE, N.W., SUITE 800, WASHINGTON, DC, 20037, US

(21) Appl. No.: 11/547,083

(22) PCT Filed: Mar. 22, 2005
(86) PCT No.: PCT/JP05/05644

§ 371 Date: Mar. 7, 2007

(30) Foreign Application Priority Data
Mar. 30, 2004 (JP) 2004-097531

(51) Int. Cl. G10L 15/04

(52) U.S. Cl. 704/251

(57) ABSTRACT

A speech recognition apparatus and speech recognition method are provided for reducing such events as erroneous recognition and disabled recognition and improving a recognition efficiency. The speech recognition apparatus generates a word model based on a dictionary memory and a sub-word sound model, and matches the word model with a speech input signal in accordance with a predetermined algorithm to perform a speech recognition for the speech input signal, wherein the apparatus comprises main matching means, operative when matching the word model with the speech input signal along a processing path indicated by the algorithm, for limiting the processing path based on a course command to select the word model most approximate to the speech input signal, local template storing means for previously typifying local sound features of spoken speeches for storage as local templates; and local matching means for matching each of component sections of the speech input signal with the local templates stored in the local template storing means to definitely determine a sound feature for each of the component sections, and generating the course command in accordance with the result of the definite determination.

### TECHNICAL FIELD

The present invention relates, for example, to a speech recognition apparatus, a speech recognition method and the like.

### BACKGROUND ART

As a conventional speech recognition method, there has been generally known a method which employs a “Hidden Markov Model” (hereinafter simply called “HMM”) shown, for example, in Non-Patent Document 1, later described. An HMM-based speech recognition approach matches an entire spoken speech including words with word sound models generated from a dictionary memory and sub-word sound models, calculates the likelihood of the matching for each word sound model, and determines a word corresponding to the most likely model as the result of the speech recognition.

General HMM-based speech recognition processing will be generally described based on FIG. 1. HMM can be regarded as a signal generating model which probablistically generates a variety of time-series signals O (O=o(1), o(2), . . . , 0(n)) while causing a state Si to transition over time. Then, FIG. 1 represents a transition relationship between the state sequence and output signal sequence O. Specifically, the HMM-based signal generating model can be thought to output one signal o(n) on the horizontal axis of FIG. 1 as the state Si, represented on the vertical axis of the same, makes a transition.

For reference, as components of this model, there are a state set of {S0, S1, Sm}, a state transition probability aij when a transition is made from a state Si to a state Si, and an output probability bi(o)=P(oISi) for outputting the signal o for each state Si. Assume that the probability P(oISi)represents a conditional probability for the set Si of a basic event. Also, S0 indicates an initial state before the signal is generated, and Sm indicates an end state after the signal has output.

Assume herein that a certain signal sequence O=o(1), o(2), . . . , o(n) in such a signal generating model. In addition, assume that state S=0, s(1), . . . , S(N), M is a certain state sequence which can output the signal sequence O. Now, the probability with which HMMΛ outputs the signal sequence O along S can be expressed by:

$$P ( O , S \vert Λ ) = {a}_{OS ( 1 )} \{ {\sum }_{n = 1}^{N - 1} {b}_{s ( n )} ( O ( n ) ) {a}_{S ( n ) S ( n + 1 )} \} {b}_{sS ( N )} ( O ( N ) ) {a}_{S ( N ) M}$$

Then, a probability P(OIΛ) with which the signal sequence O is generated from HMMΛ is calculated by:

$$P ( O \vert Λ ) = {\sum }_{s} [ {a}_{OS ( 1 )} \{ {\sum }_{n = 1}^{N - 1} {b}_{s ( n )} ( O ( n ) ) {a}_{S ( n ) S ( n + 1 )} \} {b}_{sS ( N )} ( O ( N ) ) {a}_{S ( N ) M} ]$$

In this way, P(OIΛ) can be represented by a sum total of generation probabilities through all state paths which can output the signal sequence O. However, in order to reduce the amount of memory used for calculating the probability, the Viterbi algorithm is generally used to approximate P(OIΛ) with a generation probability of only a state sequence which presents a maximum probability of outputting the signal sequence O. Specifically, a probability P(O, SˆIΛ) with which the state sequence outputs the signal sequence O, expressed by:

$$S = ar {g}_{s} max [ {a}_{OS ( 1 )} \{ {\prod }_{n = 1}^{N - 1} {b}_{s ( n )} ( O ( n ) ) {a}_{S ( n ) S ( n + 1 )} \} {b}_{sS ( N )} ( O ( N ) ) {a}_{S ( N ) M} ]$$

is regarded as the probability (OIΛ) with which the signal sequence O is generated from HMMΛ.

Generally, in the process of speech recognition processing, a speech input signal is divided into frames of approximately 20 to 20 ms long, and a feature vector o(n) is calculated for each frame for indicating a phonetic feature of the speech. In the division of the speech input signal into frames, the frames are set such that adjacent frames overlap each other. In addition, assume that temporally continuous feature vectors are regarded as the time-series signal O. Also, in word recognition, sound models are provided for so-called sub-word units, such as phonemes, syllable units, and the like.

Also, a dictionary memory used in the recognition processing stores the way as to how to arrange sub-word sound models for words w1, w2, . . . , wL which are subjected to the recognition. In accordance with the storage in the dictionary, the aforementioned sub-word sound models are coupled to generate word models W1, W2, . . . , WL. Then, the probability P(OIWi) is calculated for each word, and a word wi which presents the highest probability is output as the recognition result.

In other words, P(OIWi) can be regarded as a similarity to the word Wi. Also, by using the Viterbi algorithm for calculating the probability (OIWi), the calculation can be advanced in synchronism with the frames of the speech input signal to eventually calculate a probability value of the state sequence which presents the highest probability of state sequences which can generate the signal sequence o.

However, in the prior art described above, a search for the matching is performed for all possible state sequences, as shown in FIG. 1. For this reason, due to imperfect sound models or the influence of introduced noise, a generation probability by an incorrect state sequence of an incorrect word can be higher than a generation probability by a correct state sequence of a correct word. This can result in such events as erroneous recognition and disabled recognition, as well as in an immense increase in the amount of calculation and the amount of memory in the process of speech recognition processing, leading to a possible reduction in efficiency of the speech recognition processing.

A conventional speech recognition system using HMM is disclosed, for example, in a book entitled “Speech Recognition System” (written) by Kiyohiro Kano et al. (four), (edited by) the Institute of Information Processing (published by Ohm Co., May, 2001) (Non-Patent Document 1).

### DISCLOSURE OF THE INVENTION

A problem to be solved by the present invention is, by way of example, to provide a speech recognition apparatus and speech recognition method which reduce such events as erroneous recognition and disabled recognition, and improve a recognition efficiency.

An invention described in Claim 1 is a speech recognition apparatus which generates a word model based on a dictionary memory and a sub-word sound model, and matches the word model with a speech input signal in accordance with a predetermined algorithm to perform a speech recognition for the speech input signal, comprising main matching means, operative when matching the word model with the speech input signal along a processing path indicated by the algorithm, for limiting the processing path based on a course command to select the word model most approximate to the speech input signal, local template storing means for previously typifying local sound features of spoken speeches for storage as local templates, and local matching means for matching each of component sections of the speech input signal with the local templates stored in the local template storing means to definitely determine a sound feature for each of the component sections, and generating the course command in accordance with the result of the definite determination.

Also, an invention described in Claim 8 is a speech recognition method which generates a word model based on a dictionary memory and a sub-word sound model, and matches a speech input signal with the word model in accordance with a predetermined algorithm to perform a speech recognition for the speech input signal, comprising the steps of, when matching the word model with the speech input signal along a processing path indicated by the algorithm, limiting the processing path based on a course command to select the word model most approximate to the speech input signal, previously typifying local sound features of spoken speeches for storage as local templates, and matching each of component sections of the speech input signal with the local templates to definitely determine a sound feature for each of the component sections, and generating the course command in accordance with the result of the definite determination.

### BRIEF DESCRIPTION OF THE DRAWINGS

FIG. 1 is a state transition diagram showing transition processes of a state sequence and an output signal sequence in conventional speech recognition processing;

FIG. 2 is a block diagram showing the configuration of a speech recognition apparatus according to the present invention; and

FIG. 3 is a state transition diagram showing transition processes of a state sequence and an output signal sequence in speech recognition processing based on the present invention.

### MODE FOR CARRYING OUT THE INVENTION

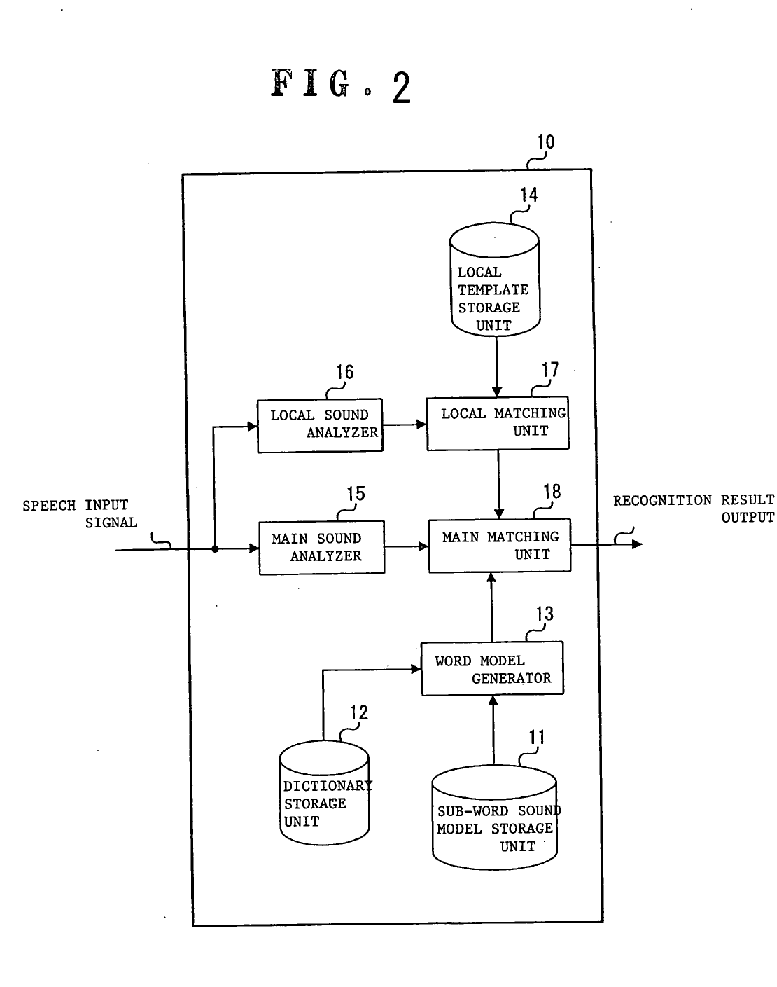

FIG. 2 shows a speech recognition apparatus which is one embodiment of the present invention. The speech recognition apparatus 10 shown in this figure may be, for example, configured to be used alone, or configured to be incorporated in another speech-related device.

In FIG. 2, a sub-word sound model storage unit 11 is a portion which stores sound models in sub-word units such as phonemes, syllables or the like. A dictionary storage unit 12 in turn is a portion which stores how the sub-word sound models are arranged for each of words subjected to speech recognition. A word model generator 13 is a portion which couples sub-word sound models stored in the sub-word sound model storage unit 11 to generate word models for use in speech recognition. Also, a local template storage unit 14 is a portion which stores local templates that are sound models which locally capture spoken contents for each of frames in a speech input signal, separately from the word models.

A main sound analyzer 15 is a portion which partitions a speech input signal into frame sections having a predetermined time length, calculates a feature vector indicative of a phonetic feature of each frame for the frame, and generates a signal time sequence of such feature vectors. Also, a local sound analyzer 16 is a portion which calculates a sound feature amount for matching each of frames in a speech input signal with the local templates.

A local matching unit 17 is a portion which compares a local template stored in the local template storage unit 14 with a sound feature amount, which is the output from the local sound analyzer 16, for each frame. Specifically, the local matching unit 17 compares both to calculate a likelihood indicative of a correlation, and definitely determines that the frame is a spoken portion corresponding to a local template when the likelihood is high.

A main matching unit 18 is a portion which compares a signal sequence of feature vectors, which is the output from the main sound analyzer 15, with each word model generated by the word model generator 13, calculates the likelihood for each word model, and matches the word model with a speech input signal. However, for a frame for which spoken contents have been definitely determined in the aforementioned local matching unit 17, restricted matching processing is performed so as to select a state path which passes the state of the sub-word sound model corresponding to the definitely determined spoken contents. In this way, the result of the speech recognition for the speech input signal is eventually output from the main matching unit 18.

The orientations of allows, representing flows of signals in FIG. 2, represent flows of main signals between respective components. For example, in regard to a variety of signals such as response signals associated with such main signals, a monitoring signal and the like, assume that transmissions in the directions opposite to the orientations of arrows are included as well. Also, paths of the arrows conceptually represent the flows of signals between the respective components, so that respective signals need not be faithfully transmitted following the paths in the figure in an actual apparatus.

Next, a description will be given of the operation of the speech recognition apparatus 10 shown in FIG. 2.

First described is the operation of the local matching unit 17. The local matching unit 17 compares a local template with a sound feature amount, which is the output from the local sound analyzer 16, to definitely determine the spoken contents of a frame only when the spoken contents of the frame is correctly captured.

The local matching unit 17 aids in the operation of the main matching unit 18 for calculating the similarity of an entire speech to each word included in a sound input signal. Therefore, the local matching unit 17 need not capture all phonemes and syllables of a speech included in a speech input signal. For example, the local matching unit 17 may be configured to utilize only those phonemes and syllables which have large speech energy, such as vowels and voiced consonants which can be relatively easily captured even at a low S/N ratio. In addition, the local matching unit 17 need not either capture all vowels and voiced consonants which appear in a speech. In other words, the local matching unit 17 definitely determines the spoken contents of a frame only when it definitely matches the spoken contents of the frame with a local template to deliver the definite information to the main matching unit 18.

The main matching unit 18, when the foregoing definite information is not sent from the local matching unit 17, calculates the likelihood of the input speech signal with a word model in synchronism with a frame output from the main speech analyzer 15 by a Viterbi algorithm similar to the aforementioned conventional word recognition. On other hand, when the definite information is sent from the local matching unit 17, the main matching unit excludes from processing paths of recognition candidates those processing paths on which a model corresponding to the spoken contents definitely determined in the local matching unit 17 does no not pass the frame.

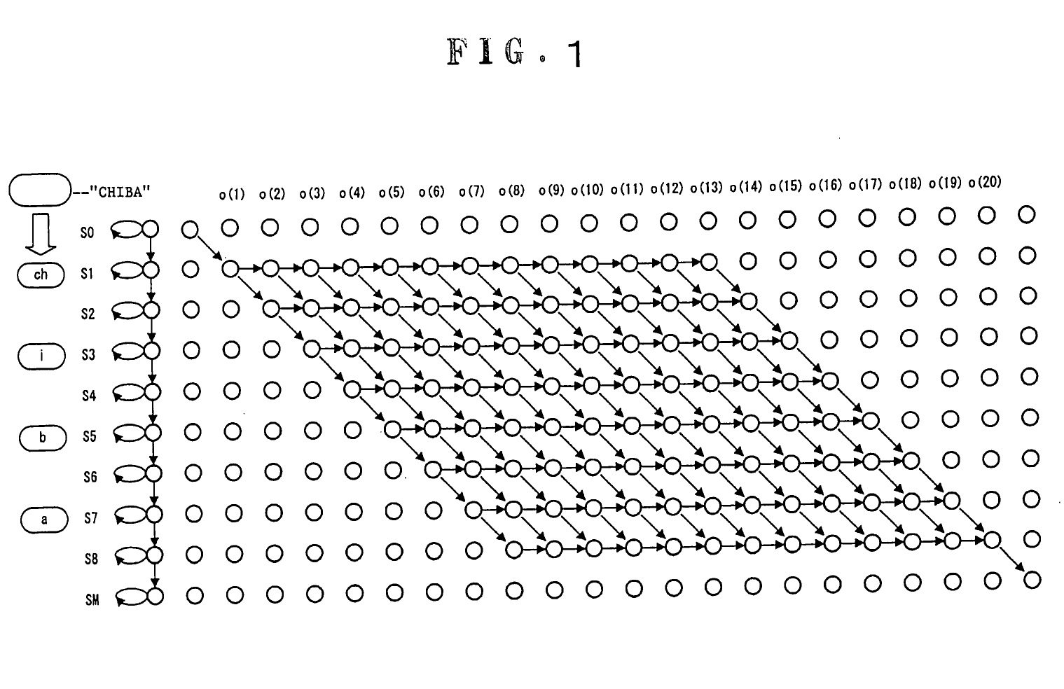

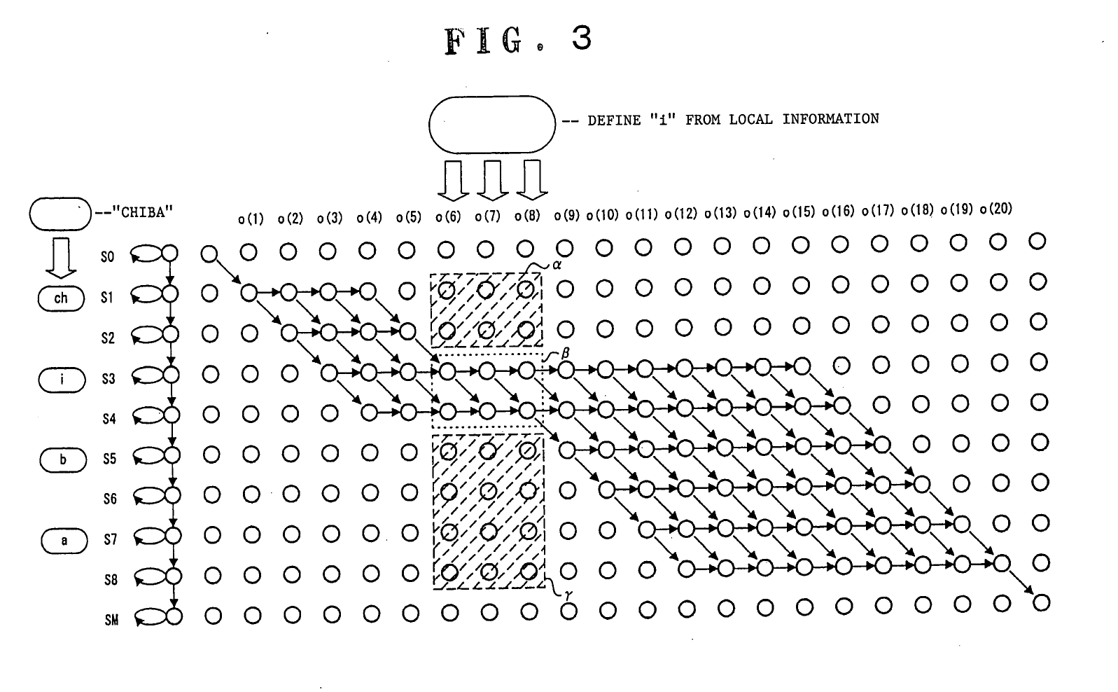

This situation is shown in FIG. 3. For reference, the situation shown in this figure represents a spoken speech “chiba” was input as a speech input signal in a manner similar to FIG. 1.

This exemplary case shows that at a timing o(6) to o(8) are output in the output signal time sequence, which are feature amount vectors, definite information showing that the spoken contents of the frame is definitely determined to be “i” by a local template is transmitted from the local matching unit 17 to the main matching unit 18. The notification of the definite information causes the matching unit 18 to exclude regions α and γ, which include paths that pass states other than “i,” from processing paths for a matching search. In this way, the main matching unit 18 can continue the processing while limiting the search processing paths only within the region β. As is apparent from a comparison with the case of FIG. 1, the foregoing processing, when performed, can largely reduce the amount of calculation during the matching search, and the amount of memory used for the calculation.

While FIG. 3 has shown an exemplary case in which definite information is sent only once from the local matching unit 17, the definite information will be sent for other frames as well when further spoken contents are definitely determined in the local matching unit 17, thereby further limiting paths on which the processing is performed on the main matching unit 18.

On the other hand, a variety of methods can be contemplated as a method of capturing a vowel portion within a speech input signal. For example, a method may be used, where a standard pattern for each vowel may be prepared, for example, by learning an average vector μi and a covariance matrix Σi based on a feature amount (multi-dimensional vector) for capturing the vowel, and the likelihood of the standard pattern and an n-th input frame may be calculated for determination. For reference, as such likelihood, for example, a probability Ei(n)=P(o′(n)Iμi, μi) or the like may be used. Here, o′(n) represents an i-th standard pattern in a future amount vector of a frame n output from the local sound analyzer 16.

Alternatively, for making correct the definite information from the local matching unit 17, the likelihood may be definitely determined for the best candidate only when there is a sufficiently large difference between the likelihood of the best candidate and the likelihood of the second best candidate. Specifically, when there are k standard patterns, likelihoods E1(n), E2(n), . . . , Ek(n) with each standard pattern of an n-th frame are calculated. Then, the largest one among them is labeled Si (=maxi{Ei(n)}, and the second largest one is labeled S2, and only when the relationship:
S1>Sth1 and (S1−S2)>Sth2
is satisfied, the spoken contents of this frame may be determined to be:
I=argmaxi{Ei(n)}
Sth1, Sth2 are predetermined thresholds appropriately defined in an actual use.

Further, without definitely determining a unique result for the local matching, definite information which permits a plurality of processing paths may be delivered to the main matching unit 18. For example, as a result of performing the local matching, definite information delivered herein may inform that the vowel of the frame is “a” or “e.” Accordingly, the main matching unit 18 leaves processing paths on which word models of “a” and “e” correspond to this frame.

Also, as the foregoing feature amount, a parameter such as MFCC (mel frequency cepstrum coefficient), LPC cepstrum, or logarithmic spectrum may be used. While these feature amounts may be similar in configuration to the sub-word sound model, the number of dimensions may be increased over the sub-word sound model in order to improve the accuracy of estimating the vowel. Even in this event, an increase in the amount of calculation associated with the change is slight because the number of local templates are several, which is relatively small.

Further, formant information of a speech input signal may be used as the feature amount. Generally, since the frequency bands of the first formant and second formant well represent the features of the vowels, information on these formants can be used as the aforementioned feature amount. Alternatively, a perception location on an internal ear basement membrane is found from the frequency and amplitude of a main formant, and this can be used as the feature amount.

Also, since the vowels are voiced sounds, a determination may be first made on whether or not a pitch can be detected within a basic frequency range of a speech in each frame, and the matching may be made with vowel standard patterns only when it can be detected in order to more securely capture the vowels. Otherwise, for example, the vowels may be captured by a neural net.

While the foregoing description has been made given, as an example, the case where the vowels are used as local templates, the present invention is not limited to this exemplary case, but any sound can be used as a local template as long as characteristic information can be extracted therefrom in order to capture spoken contents without fail.

Also, this embodiment can be applied not only to word recognition, but to continuous word recognition and large vocabulary continuous speech recognition.

As described above, according to the speech recognition apparatus or speech recognition method of the present invention, it is possible to delete candidate paths which clearly result in incorrect solution in the process of matching processing, it is possible to delete part of factors by which speech recognition results in erroneous recognition or disabled recognition. Also, since candidate paths to be searched can be reduced, the amount of calculation and the amount of memory used in the calculation can be reduced to improve a recognition efficiency. Further, since the processing according to this embodiment can be executed in synchronism with frames of a speech input signal, like a normal Viterbi algorithm, a calculation efficiency can be improved as well.

1. A speech recognition apparatus which generates a word model based on a dictionary memory and a sub-word sound model, and matches the word model with a speech input signal in accordance with a predetermined algorithm to perform a speech recognition for the speech input signal, comprising:
main matching means, operative when matching the word model with the speech input signal along a processing path indicated by the algorithm, for limiting the processing path based on a course command to select the word model most approximate to the speech input signal;
local template storing means for previously typifying local sound features of spoken speeches for storage as local templates; and
local matching means for matching each of component sections of the speech input signal with the local templates stored in said local template storing means to definitely determine a sound feature for each of the component sections, and generating the course command in accordance with the result of the definite determination.

2. A speech recognition apparatus according to claim 1, characterized in that said algorithm is a hidden Markov model.

3. A speech recognition apparatus according to claim 1, characterized in that said processing path is calculated by a Viterbi algorithm.

4. Speech recognition apparatus according to claim 1, characterized in that said local matching means generates a plurality of the policy instructions in accordance with the likelihood of the matching between the component section and the local template when the sound feature amount is definitely determined.

5. A speech recognition apparatus according to claim 1, characterized in that said local matching means generates the course command only when the difference between the highest likelihood and the next highest likelihood of the matching exceeds a predetermined threshold.

6. A speech recognition apparatus according to claim 1, characterized in that said local template is generated based on a sound feature amount of a vowel portion included in the speech input signal.

7. A speech recognition apparatus according to claim 1, wherein said local template is generated based on a sound feature amount of a consonant portion included in the speech input signal.

8. A speech recognition method which generates a word model based on a dictionary memory and a sub-word sound model, and matches a speech input signal with the word model in accordance with a predetermined algorithm to perform a speech recognition for the speech input signal, comprising the steps of:
when matching the word model with the speech input signal along a processing path indicated by the algorithm, limiting the processing path based on a course command to select the word model most approximate to the speech input signal;
previously typifying local sound features of spoken speeches for storage as local templates; and
matching each of component sections of the speech input signal with the local templates to definitely determine a sound feature for each of the component sections, and generating the course command in accordance with the result of the definite determination.

9. Speech recognition apparatus according to claim 2, characterized in that said local matching means generates a plurality of the policy instructions in accordance with the likelihood of the matching between the component section and the local template when the sound feature amount is definitely determined.

10. Speech recognition apparatus according to claim 3, characterized in that said local matching means generates a plurality of the policy instructions in accordance with the likelihood of the matching between the component section and the local template when the sound feature amount is definitely determined.

11. A speech recognition apparatus according to claim 2, characterized in that said local matching means generates the course command only when the difference between the highest likelihood and the next highest likelihood of the matching exceeds a predetermined threshold.

12. A speech recognition apparatus according to claim 3, characterized in that said local matching means generates the course command only when the difference between the highest likelihood and the next highest likelihood of the matching exceeds a predetermined threshold.

13. A speech recognition apparatus according to claim 2, characterized in that said local template is generated based on a sound feature amount of a vowel portion included in the speech input signal.

14. A speech recognition apparatus according to claim 3, characterized in that said local template is generated based on a sound feature amount of a vowel portion included in the speech input signal.

15. A speech recognition apparatus according to claim 2, wherein said local template is generated based on a sound feature amount of a consonant portion included in the speech input signal.

16. A speech recognition apparatus according to claim 3, wherein said local template is generated based on a sound feature amount of a consonant portion included in the speech input signal.
